(19) United States
(12) Patent Application Publication
(10) Pub. No.: US 2004/0125274 A1
(43) Pub. Date: Jul. 1, 2004

(54) Image display apparatus

(76) Inventor: Tsutou Asakura, Odawara-shi (JP)

Correspondence Address: NATH & ASSOCIATES, PLLC, Sixth Floor, 1030 15th Street, N.W., Washington, DC, 20005, US

(21) Appl. No.: 10/726,687

(22) Filed: Dec. 4, 2003

(30) Foreign Application Priority Data
Dec. 26, 2002 (JP) P2002-376642
Sep. 2, 2003 (JP) P2003-310047

(51) Int. Cl. G02F 1/1335

(52) U.S. Cl. 349/95

(57) ABSTRACT

An image display apparatus comprising a light source 11 and a primary lens array 13, secondary lens array 14 and a superimposing lens 16 for convoluted illumination of a plurality of secondary and tertiary light source images formed from the light source, a liquid crystal light valve 18 for passing light beams of the convoluted illumination light beams that are far from the optical axis L0 of wavelength regions for which the (intensity) level is reduced and passing remaining light beams unrestricted, and a projection lens projecting light modulated by the liquid crystal light valve 18.

### FIELD OF THE INVENTION

The present invention relates to an image display apparatus for the projection and display of an image modulated using spatial light modulating elements such as reflective or transmission type liquid crystal light valves and the like.

### BACKGROUND OF THE INVENTION

Image display apparatuses have conventionally involved modulation of light with a liquid crystal light valve, a type of spatial light modulating element and projection of the image onto a screen. Such image display apparatuses employ a reflective or transmission liquid crystal light valve to modulate the image by controlling the light for each pixel of the light valve.

FIG. 1A and FIG. 1B illustrate the configuration of an image display apparatus in outline.

FIG. 1A illustrates a lens array system type image display apparatus.

A lens array type image display apparatus employs a lens array as a means for convoluted illumination for convoluted illuminating of a liquid crystal light valve.

This image display apparatus comprises a light source 111, a reflector 112 reflecting light emitted from the light source 111 along an optical axis L0, a primary lens array (fly-eye lens) 113, a secondary lens array (fly-eye lens) 114, a superimposing lens 116, a condenser lens 117 and a liquid crystal light valve 118.

On the primary and secondary lens arrays 113 and 114 a plurality of lens cells having apertures of a shape similar to those in the liquid crystal light valve 118 are arrayed in two dimensions, with the emitting aperture surfaces of the reflector 112 spatially separated.

Each lens cell in the primary lens array 113 focuses a beam of light on the corresponding lens cell in the secondary lens array 114, forming on the secondary lens array 114 the same number of secondary images of the light source as there are lens cells in the primary lens array 113. Each lens cell in the secondary lens array 114 forms an image of each corresponding lens cell aperture of the primary lens array 113 on the surface of the liquid crystal light valve 118. The superimposing lens 116 aligns the center of each lens cell with the center of the liquid crystal light valve 118 so that the image of each lens cell of the primary lens array 113 is superimposed on the surface of the liquid crystal light valve 118.

In this way, a plurality of secondary images of the light source are formed in the secondary lens array 114 and a plurality of tertiary images of the light source are formed in the superimposing lens 116.

Consequently, the intensity of the light beams reflected from the reflector 112 is integrated and the liquid crystal light valve 118 is convolutedly illuminated with a uniform intensity distribution due to this plurality of secondary and tertiary images of the light source. In this manner, the primary and secondary lens arrays 113 and 114 and the superimposing lens 116 provide convoluted illumination means.

The condenser lens 117 is positioned such that the light from the liquid crystal light valve 118 is emitted in the direction of the incident iris of the projection lens (not shown in the drawing).

The liquid crystal light valve 118 comprises a transmission or reflective liquid crystal panel in which a plurality of liquid crystal cells are arrayed in two dimensions and an analyzer (polarizing panel) transmitting only light polarized in the prescribed direction. The liquid crystal panel is controlled with electrical signals to modulate the transmitted or reflected light.

FIG. 1B illustrates a rod integrator system image display apparatus.

The rod integrator system image display apparatus employs a rod integrator (glass rod) in place of a lens array as means for convoluted illumination for convolutedly illuminating the liquid crystal light valve.

This image display apparatus comprises a light source 111, a reflector 112 reflecting light emitted from the light source 111 along the optical axis L0, a glass rod 121 as a rod integrator, an outward directing lens 122, a superimposing lens 116, a condenser lens 117 and a liquid crystal light valve 118.

In this image display apparatus, the reflector 112 illuminates the incident face of the glass rod 121 by focusing thereon the light from the light source 111 along the optical axis L0. The light beam directed to the incident face of the glass rod 121 is superimposed within the glass rod 121 by repeating and convoluting complete reflection, ensuring a uniform intensity distribution of the emitted light. The outward directing lens 122 receiving incident of the emitted light from the glass rod 121 focuses the emitted light from the glass rod 121 onto the superimposing lens 116. A plurality of tertiary images of the light source are formed onto the liquid crystal light valve by the superimposing lens 116, the number of such images being in accordance with the number of cycles of reflection within the glass rod 121.

In this manner, the glass rod 121, the outward directing lens 122 and the superimposing lens 116 provide a means for convoluted illumination for convolutedly illuminating the liquid crystal light valve 118.

The image display apparatus illustrated in FIG. 1A and FIG. 1B displays in monochrome. With an image display apparatus that displays in color, the light from the means for convoluted illumination is separated into light of the three primary colors red, green and blue (RGB), each being modulated by a corresponding liquid crystal light valve and subsequently the RGB light is recombined for projection.

Such an image display apparatus for color display requires color balance (white balance) adjustment to adjust the proportions of the RGB light. This color balance adjustment involves adjustment of the size of the signals employed in controlling the RGB liquid crystal light valves. Intensity of transmitted (or reflected) light is increased in accordance with the size of the electrical signal applied to the liquid crystal light valve.

For example, when color temperature is set to a high value, the R and G electrical signals applied to the liquid crystal light valves are reduced to ensure that the intensity of R and G light is reduced relative to that of B light, thus reducing modulation of the R and G liquid crystal light valves.

When color temperature is set to a low value, the B and G electrical signals applied to the liquid crystal light valves are reduced to ensure that the intensity of B and G light is reduced relative to that of R light, thus reducing modulation of the B and G liquid crystal light valves.

There is still a need however concerning conventional image display apparatuses to achieve a reduction in size and increased brightness of the projected image. This requires that an image display apparatus directs light to the liquid crystal light valve over a wider range via a short optical path and a large diameter light beam (i.e. a small F-number for the illumination optics system) of sufficient brightness to illuminate the liquid crystal light valve.

Conventional art relating the foregoing image display apparatus is disclosed in, e.g., Japanese Patent Laid-Open Publication No.H7-49494 and Japanese Patent Laid-Open Publication No.2000-137289.

In practice, when a liquid crystal light valve is illuminated with the above-described means for convoluted illumination and RGB color balance is adjusted with an electrical signal in an image display apparatus enlarging and projecting the information displayed by this liquid crystal light valve, a problem arises wherein the color contrast of the reduced signal deteriorates.

Further, if by adjusting brightness RGB signals are diminished, reducing modulation of the liquid crystal, a problem arises wherein system contrast deteriorates.

Moreover, reducing F-number for the illumination optics system also increases light leakage from the liquid crystal light valve when displaying black information and a problem arises wherein contrast deteriorates.

FIG. 2 illustrates the relationship between input signal and light output in an image display apparatus.

C in the diagram represents light output L when black information for which input signal S is less than a prescribed value is displayed. The ideal level for light output L is conventionally zero, however the performance of the color separation and synthesis optics systems and the performance of the liquid crystal employed in the liquid crystal light valve 118, are such that light is output at level C as leaked light. When input signal S reaches a peak, light output level L reaches level A. The contrast ratio CR of the image display apparatus is determined by A/C in this case.

In practice, when light output L is reduced and the signal adjusted to the level A′ light output to obtain a color balance, the contrast ratio CR becomes A′/C and contrast may deteriorate dramatically.

Further, the contrast ratio CR also deteriorates with an increase in the C level with light leakage due to a reduction in the F-number for the illumination optics system.

FIG. 3A and FIG. 3B are cross-sectional views illustrating the direction of polarization as illuminating light passes through a vertically oriented liquid crystal when black information is input and shows the relationship between the F-number and light leakage from the liquid crystal light valve.

This liquid crystal light valve is shown schematically and comprises a liquid crystal panel 41 and an analyzer (polarizing panel) 42. In the drawing, no signal is applied to the liquid crystal panel 41 and the liquid crystal molecules are arrayed such that the long axes are vertical in the liquid crystal panel 41.

This description employs a reflective liquid crystal panel 41, however the relationship between F-number, incident angle and light leakage is the same as for a transmission liquid crystal panel.

FIG. 3A illustrates the case in which the light component L1 either vertical or at a small angle (large F-number) to the liquid crystal panel 41 is transmitted (reflected). As the long axes of the liquid crystal molecules are arrayed in the light L1 direction, the light L2 transmitted through (reflected from) the liquid crystal is not modulated and is absorbed and interrupted in the analyzer 42.

FIG. 3B illustrates the case in which the light component L1 at a large angle (small F-number) to the liquid crystal panel 41 is transmitted (reflected). Even when the liquid crystals do not react and the long axes of the liquid crystals are arrayed in the vertical direction of the liquid crystal panel 41, this light beam enters at an angle to the liquid crystal molecules and is therefore modulated to a small extent. The modulated portion of the light therefore passes through the analyzer 42 and is leaked, that is to say, it increases the level C shown in FIG. 2 (the base level of light output when black information is displayed is raised).

With the foregoing in view, it is an object of the present invention to provide an image display apparatus wherein color balance may be adjusted without deterioration in contrast and furthermore, wherein increasing the F-number of the illumination optics system for the adjusted color improves contrast.

### BRIEF DESCRIPTION OF THE DRAWINGS

FIG. 1A and FIG. 1B are outline views illustrating the configuration of an image display apparatus.

FIG. 2 illustrates the relationship between input signal and light output in an image display apparatus.

FIG. 3A and FIG. 3B are a cross-sectional views illustrating the direction of polarization when illuminating light passes through a vertically oriented liquid crystal when black information is input to an image display apparatus.

FIG. 4A and FIG. 4B illustrate the configuration of an image display apparatus according to an embodiment of the present invention.

FIG. 5A and FIG. 5B are perspective views of the filter of the image display apparatus shown in FIG. 1.

FIG. 6A and FIG. 6B provide plane and side views illustrating an embodiment using a lens array illumination system, in an embodiment further providing a barrier member.

FIGS. 7A and 7B provide plane and side views illustrating an embodiment using a lens array illumination system, in an embodiment further providing a rod integrator illumination system.

FIG. 8 is a diagram illustrating the relationship between input signal and light output in the various aforementioned embodiments.

FIG. 9A and FIG. 9B are front views illustrating an embodiment in which the filter and barrier member are provided after the lens array.

FIG. 10A and FIG. 10B are side views illustrating an embodiment in which the filter and barrier member are provided after the lens array.

FIG. 11 is a side view illustrating in greater detail a configuration of an image display apparatus related to the present invention.

FIG. 12 is a side view of a configuration of the image display apparatus shown in FIG. 8 in which a barrier member is provided.

FIG. 13 is a side view illustrating the configuration of the mechanism for movement of the barrier member in the image display apparatus according to the present embodiment.

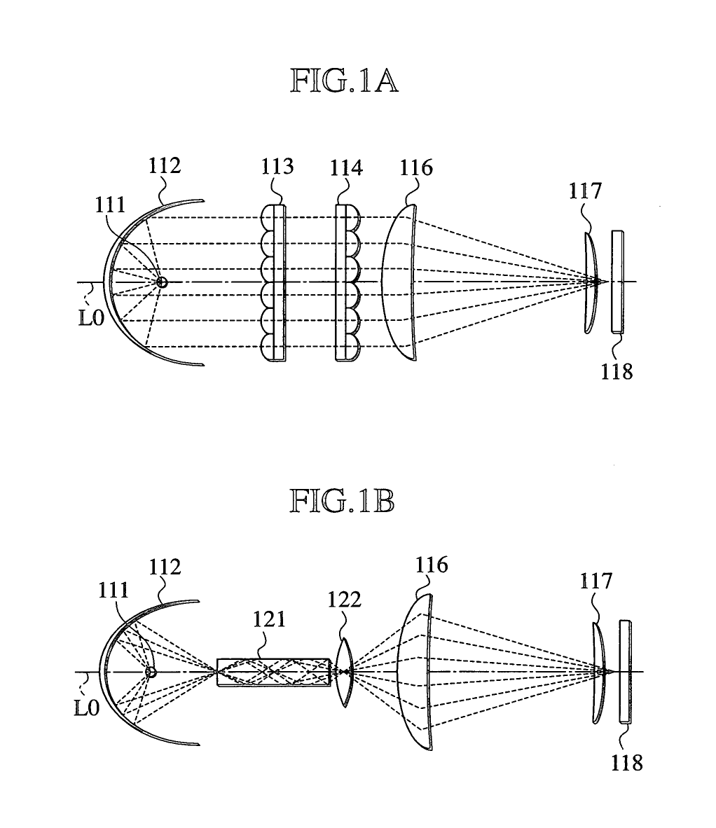

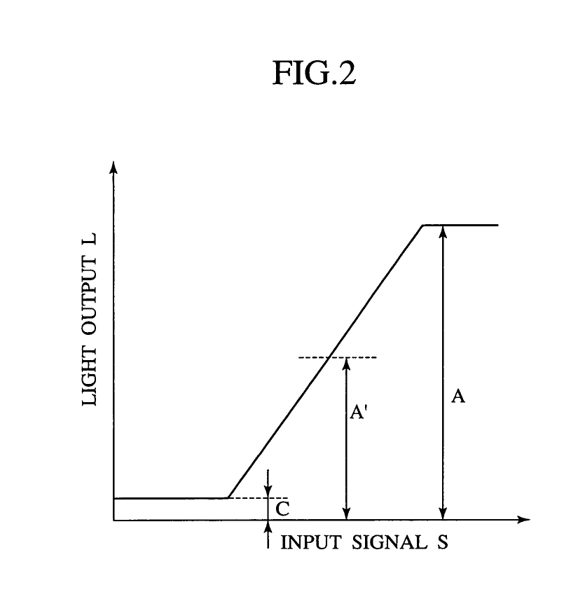

### SUMMERY OF THE INVENTION

The image display apparatus related to the present invention includes: a white light source for emitting white light in the form of a light beam of a prescribed cross-sectional area, three spatial light modulating elements for modulating three primary colors, respectively, a focusing lens for focusing the light beam emitted from the white light source, a primary means of adjustment for adjusting the color balance of the white light entering or leaving the focusing lens, means of separating and synthesizing for separating the three primary colors of the light for which color balance has been adjusted by the primary means of adjustment, for directing light of the three primary colors to the three spatial modulating elements and for synthesizing light of the three primary colors modulated with the three spatial light modulating elements, and means of projection for projecting light synthesized with the means of separating and synthesizing.

Preferably, the primary means of adjustment adjust the three primary colors in order to interrupt light in a wavelength region for which the (intensity) level is reduced in light beams directed to the spatial light modulating elements and far from the optical axis.

This image display apparatus operates such that, since light intensity is reduced in a relative manner when black information from the spatial light modulating elements is displayed, contrast does not deteriorate despite adjustment of color balance (white balance). This is because the intensity of the light transmitted (or reflected) by the spatial light modulating elements is not controlled electrically, rather, the intensity of the light directed to the spatial light modulating elements is controlled optically.

Preferably, the image display apparatus related to the present invention provide a barrier member to interrupt all wavelength regions in white light in at least part of a light beam entering or leaving the focusing lens and a secondary means of adjustment to adjust the intensity of white light in a light beam in which all wavelength regions are interrupted by the barrier member.

This image display apparatus operates such that wavelength regions for which the intensity level is reduced in light beams far from the optical axis are interrupted by the barrier member. The actual diameter of the illuminating light beam may therefore be reduced and the F-number increased, that is to say, as the angle of light directed into the spatial light modulating element modulating the light is reduced, leakage of light transmitted through (reflected from) the spatial light modulating element when black information is displayed may be reduced. Accordingly, the level of intensity of the output light when black information is displayed is therefore reduced and contrast may be improved.

Preferably, the image display apparatus related to the present invention provide a lens array, a glass rod, or an internally reflecting columnar mirror between the white light source and the focusing lens.

Preferably, spatial light modulating elements are provided corresponding to the modulated RGB wavelength regions of light from the color separation optics system.

Preferably, a color synthesis optics system is provided for synthesizing light of RGB wavelength regions modulated respectively by the spatial light modulating element liquid crystals, corresponding to that RGB.

Preferably, the projection lens project light synthesized with the color synthesis optics system.

The present invention allows adjustment of the color balance of an image display apparatus without deterioration in contrast and furthermore, the F-number of the illumination optics system may be increased in order to improve contrast for the adjusted color.

### DETAILED DESCRIPTION OF THE INVENTION

The embodiments of the image display apparatus related to the present invention will now be described with reference to the accompanying drawings.

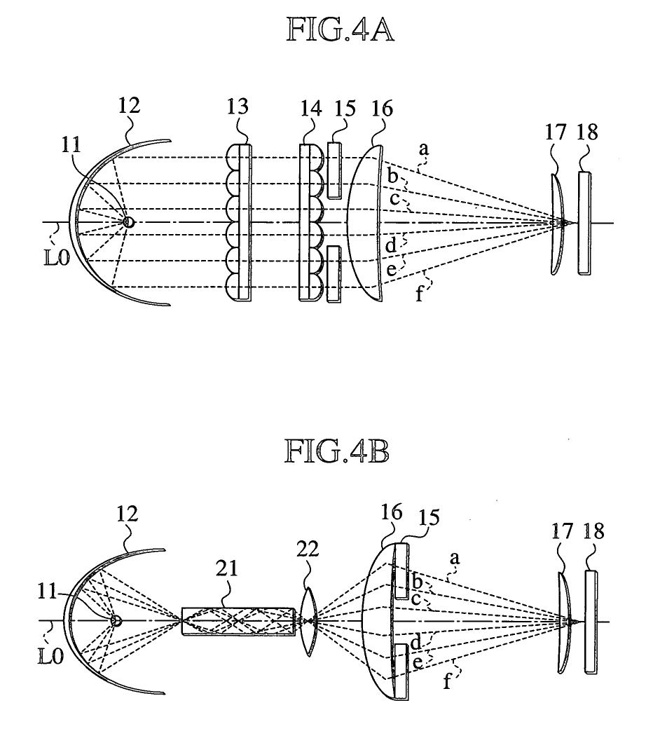

FIG. 4A and FIG. 4B illustrate the configuration of an image display apparatus according to an embodiment of the present invention.

In order to simplify the description, FIG. 4A and FIG. 4B illustrate a monochrome image display apparatus wherein light emitted from a light source 11 irradiates a single liquid crystal light valve 18. FIG. 4A and FIG. 4B illustrate the principle of the present invention by which color separation and synthesis optics systems to separate and synthesize RGB of light are provided in a color image display apparatus requiring color balance (white balance) adjustment.

FIG. 4A illustrates a lens array system image display apparatus.

This image display apparatus comprises a light source 11 and a reflector 12 reflecting light emitted from a light source along an optical axis L0.

A lamp emitting white light such as a high voltage mercury lamp or metal halide lamp or the like is employed as the light source 11. A reflector 12 provides a reflective surface in the form of an ellipsoid of revolution around the optical axis L0, the light emitted from the light source 11 being reflected from the reflective surface to form a parallel beam of light along the optical axis L0.

Moreover, this image display apparatus comprises a primary lens array (fly-eye lens) 13, a secondary lens array (fly-eye lens) 14, a filter 15, a superimposing lens 16, a condenser lens 17 and a liquid crystal light valve 18.

A plurality of lens cells having a shape similar to the liquid crystal light valve 18 are arrayed in two dimensions on the primary and secondary lens arrays 13 and 14 such that the reflector 12 spatially separates apertures emitting light beams of a prescribed cross-sectional area.

Each lens cell in the primary lens array 13 focuses a beam of light on the corresponding lens cell in the secondary lens array 14, forming on the secondary lens array 14 the same number of secondary images of the light source as there are lens cells in the primary lens array 13.

Each lens cell in the secondary lens array 14 forms, on the surface of the liquid crystal light valve 18, an image of the corresponding primary lens array 13 lens cell aperture. The superimposing lens 16 aligns the center of each lens cell with the center of the liquid crystal light valve 18 so that the image of each lens cell of the primary lens array 13 is superimposed on the surface of the liquid crystal light valve 18.

The filter 15 interrupts light beams passing through the primary and secondary lens arrays 13 and 14 far from the optical axis L0 and of wavelength regions for which the level is to be reduced. The remaining light beams pass through the filter 15 unrestricted.

The condenser lens 17 is positioned such that illuminating light from the liquid crystal light valve 18 is emitted in the direction of the incident iris of the projection lens (not shown in the drawing).

The liquid crystal light valve 18 comprises a liquid crystal panel in which a plurality of liquid crystal cells are arrayed in two dimensions and an analyzer (polarizing panel) transmitting only light polarized in a prescribed direction. An image is modulated by controlling the intensity of the light passing through each liquid crystal cell.

This image display apparatus operates such that a plurality of secondary images of the light source formed from light focused by the primary lens array 13 are formed on the secondary lens array 14. Moreover, a tertiary image of the light source formed from light focused by the secondary lens array 14 is formed on the superimposing lens 16. This tertiary image of the light source is used for convoluted illumination of the liquid crystal light valve 18 with a uniform intensity distribution obtained by integrating the intensity of the light beam. In this image display apparatus the means for convoluted illumination for performing convoluted illumination comprises primary and secondary lens arrays 13 and 14 and a superimposing lens 16.

The filter 15 is provided between the secondary lens array 14 on which the secondary image of the light source is formed and the superimposing lens 16 on which the tertiary image of the light source is formed and interrupts the prescribed wavelength regions applicable to light beams of an area equivalent to the reduced level. The remaining light beams pass through the filter 15 unrestricted.

The filter 15 interrupts light beams of the desired wavelength regions commencing with those farthest from the optical axis. Accordingly, this reduces the diameter of the light beams passing through the filter 15. That is to say, the diameter of the light beams is reduced by the filter 15 only for the desired wavelength regions, however as the light intensity on the periphery of the light beams is reduced for the overall light beam incorporating all wavelength regions, it is possible in practice to reduce the diameter of the light beams. In other words, in practice it is possible to increase the F-number.

As the diameter of the light beams is reduced in practice in this manner, light far from the optical axis L0 and directed to the liquid crystal light valve 18 at a large angle, is reduced. Accordingly, as described subsequently, this also reduces light leakage when the liquid crystal light valve 18 displays black information.

For example, when an R transmission filter is applied to a light beam of an area equivalent to the reduced light intensity level, light rays a, b, e and f consist only of R light and light rays c and d to which the filter 15 is not applied consist of R+G+B, that is to say white light. The light convoluted on the liquid crystal light valve 18 therefore has the G and B components removed and is consequently of a low color temperature.

The drawing illustrates an example in which the filter 15 is provided between the secondary lens array 14 and the superimposing lens 16, however the filter 15 may also be provided between the primary and secondary lens arrays 13 and 14.

FIG. 4B illustrates an image display apparatus employing a glass rod system.

Compared with the image display apparatus with lens array system illustrated in FIG. 4A, this image display apparatus differs in the features that a glass rod 21 and outward directing lens 22 are employed in place of the primary and secondary lens arrays 13 and 14 and that the filter 15 is provided behind the superimposing lens 16. Parts similar to the lens array system illustrated in FIG. 4A are identified with the same reference symbols and are omitted from the description.

The reflector 12 provides a reflective surface in the form of an ellipsoid of revolution, reflecting the light emitted from the light source 11 and focusing that light, directing this light onto the incident face of the glass rod 21.

Inside the glass rod 21 light output from the reflector 12 is repeatedly and completely reflected. The outward directing lens 22 directs the light emitted from the glass rod 21 to the relay lens 16.

At this time, a plurality of secondary images of the light source are formed on the emitting face of the glass rod 21. Furthermore, a plurality of tertiary images of the light source are formed on the superimposing lens 16. The number of these secondary and tertiary images of the light source corresponds to the number of cycles of total reflection within the glass rod 21.

The filter 15 is provided at a stage subsequent to the superimposing lens 16 on which the tertiary images of the light source are formed and interrupts the desired wavelength regions applicable to light beams of an area equivalent to the reduced light intensity level. The remaining light beams pass through the filter 15 unrestricted. In the same manner as the lens array system image display apparatus shown in FIG. 4A and FIG. 4B illustrate an R transmission filter wherein light rays a, b, e, and f consist only of R light and light rays c and d consist of R+G+B, that is to say white light.

As described previously, in order to simplify the description, the image display apparatus illustrated in FIG. 4A and FIG. 4B omit parts related to the color separation and synthesis optics systems. In practice, liquid crystal light valves are provided to modulate each of the RGB components of the light. Moreover, a color separation optics system is provided in the stage prior to the liquid crystal light valves to separate the light into its RGB components and a color synthesis optics system is provided in the stage subsequent to the liquid crystal light valves to combine the RGB components. The projection lens projects the light synthesized in this color synthesis system.

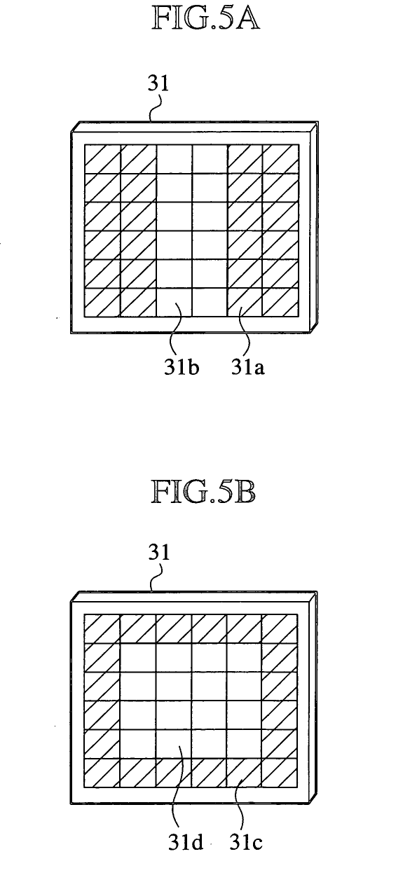

FIG. 5A and FIG. 5B are perspective views of the filter used in the image display apparatus shown in FIG. 4A and FIG. 4B.

Filter 31 in the drawing is a specific example of the filter 15 illustrated in FIG. 4A and FIG. 4B. This filter 31 comprises a 6×6 array of elements arranged vertically and horizontally in which transmission of light may be controlled for each element. That is to say, it is possible to switch each element between a condition wherein light of wavelength regions for which the level is to be reduced is interrupted and a condition wherein light, passes unrestricted.

For example, as illustrated in FIG. 5A and FIG. 5B, control is possible such that light at elements 31a in each of the two rightmost and two leftmost columns is interrupted in wavelength regions for which the light intensity level is reduced and at elements 31b in the remaining two central columns, light is passed unrestricted.

In this manner, control is possible such that light in wavelength regions for which the level is reduced is interrupted commencing with elements farthest from the optical axis L0 of the lens and at the remaining elements light passes unrestricted, such that light intensity is symmetrical around a single straight line perpendicular to the optical axis passing through the center of the filter 31.

Furthermore, as shown in FIG. 5B for example, control is possible such that light in wavelength regions for which the level is reduced is interrupted at elements 31c at the periphery of the array away from the optical axis and at the remaining four elements 31d in the center light passes unrestricted.

In this manner, elements comprising the filter 31 are controlled such that light in wavelength regions for which the level is reduced is interrupted commencing with elements away from the optical axis and at the remaining elements light passes unrestricted.

In the present embodiment, control is such that, at elements close to the optical axis L0 light passes unrestricted for both FIG. 5A and FIG. 5B. Accordingly, the diameter of the light beam illuminating the liquid crystal light valve 18 is reduced in practice, thus increasing the F-number. Moreover, light directed to the liquid crystal light valve 18 at a large angle may be controlled.

When a lens array is employed as illustrated in FIG. 4A it is possible to arrange the elements comprising the filter 31 to correspond to the arrangement of the lens cells comprising the lens array. By arranging filter 31 elements and lens array in this manner to correspond with the disposition of the lens cells it is possible to reduce irregular coloring resulting from mismatching in this arrangement.

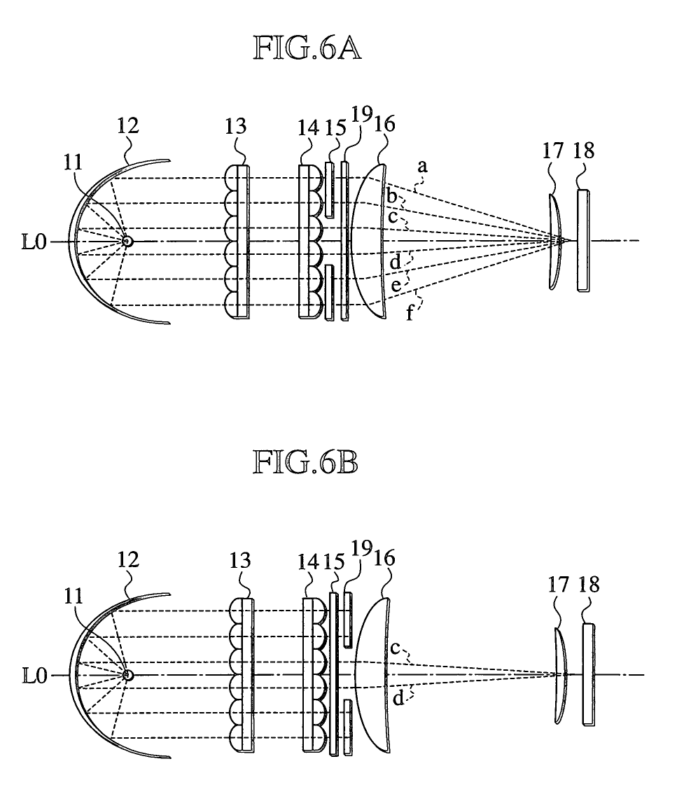

FIG. 6A and FIG. 6B illustrate an embodiment employing a system for lens array system illumination, together with plane and side views illustrating an embodiment comprising a barrier member. FIG. 6A is the plane view and FIG. 6B is the side view.

In FIG. 6A and FIG. 6B, the secondary lens array 14 on which the secondary images of the light source are formed is followed by the filter 15 interrupting wavelength regions for which the light intensity level is to be reduced and which covers the lens aperture for the lens array 14 to a level equivalent to which the light intensity is reduced, as in the embodiment illustrated in FIG. 4A. That is to say, of the light beams passing through the primary and secondary lens arrays 13 and 14, the filter 15 interrupts those far from the optical axis L0 in wavelength regions for which the light intensity level is reduced and remaining light beams pass unrestricted. For example, when an R transmission filter is installed the light rays a, b, e, and f consist only of R light, light rays c and d consist of R+G+B, that is to say white light and the light superimposed on the liquid crystal light valve 18 therefore has the G and B components removed and is consequently of a low color temperature.

Furthermore, in this embodiment, the barrier member 19 is positioned perpendicular to the direction in which the filter 15 is installed and covers the number of apertures in the lens array equivalent to which the light intensity level is to be reduced. This barrier member 19 consists, for example, of a reflecting mirror to reflect all wavelength regions of the light beam, or a black barrier member to absorb light of all wavelength regions.

Another configuration of this embodiment is as shown in FIG. 4A.

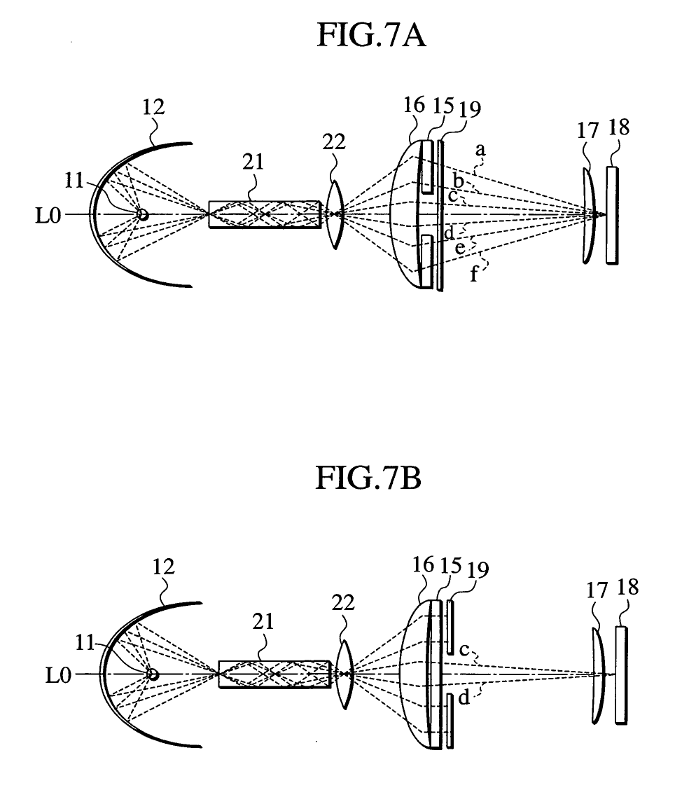

FIG. 7A and FIG. 7B provide plane and side views illustrating an embodiment using a lens array illumination system, in an embodiment further providing a rod integrator illumination system. FIG. 7A is the plane view and FIG. 7B is the side view.

In FIG. 7A and FIG. 7B, as with the embodiment illustrated by FIG. 4B, the superimposing lens 16 on which the tertiary images of the light source are formed is followed by the filter 15 interrupting wavelength regions for which the light intensity level is to be reduced, installed so as to correspond to the cross-sectional area to which the light intensity is to be reduced. In other words, of the light beams passing through the rod integrator 21, the filter 15 interrupts those far from the optical axis L0 in wavelength regions for which the level is reduced and remaining light beams as they are pass unrestricted. For example, when an R transmission filter is installed the light rays a, b, e, and f consist only of R light, light rays c and d consist of R+G+B, that is to say white light and the light superimposed on the liquid crystal light valve 18 therefore has the G and B components removed and is consequently of a low color temperature.

Moreover, in this embodiment, the barrier member 19 is positioned perpendicular to the direction in which the filter 15 is installed and covers the number of apertures in the lens array equivalent to which the light intensity level is to be reduced. This barrier member 19 consists, for example, of a reflecting mirror to reflect all wavelength regions of the light beam, or a black barrier member to absorb all wavelength regions of the light.

Another configuration of this embodiment is as shown in FIG. 4B.

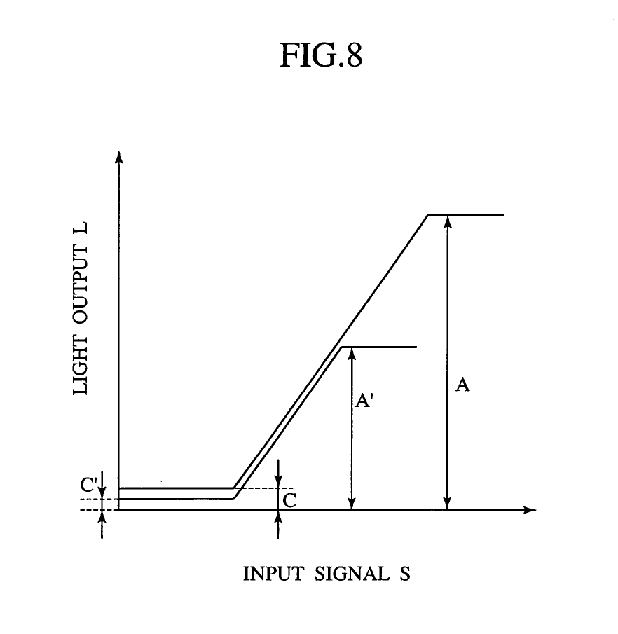

FIG. 8 is a diagram illustrating the relationship between input signal and light output in the various aforementioned embodiments.

This diagram illustrates the relationship between input signal S input to the liquid crystal light valve 18 and the light output L passing through the liquid crystal light valve 18.

When input signal S is at peak level, light output L is at level A. Light output L when black information for which input signal S is less than a prescribed value is displayed is at level C.

The ideal level for light output L when black information is displayed is zero, however the performance of the color separation and synthesis optics systems and the performance of the liquid crystal employed in the liquid crystal light valve 18, are such that light is output at level C as leaked light. As described previously, in the image display apparatus of this embodiment, the F-number is large and the incident angle of the illuminating light on the liquid crystal light valve 18 is small so light leakage in the liquid crystal light valve 18 is therefore small.

The contrast ratio CR of the image display apparatus is determined by A/C in this case. In this embodiment, light leakage is small and level C when black information is displayed is low and the contrast ratio CR is therefore large.

When light output L is reduced at the input signal S peak so as to reach level A′ in order to adjust color balance (white balance), light leakage when black information is displayed is also reduced to level C′. In this embodiment, this is due to the fact that color balance adjustment is achieved by limiting light intensity in the prescribed wavelength regions with the filter 15. Light leakage C′ when black information is displayed is therefore reduced in accordance with the light intensity interrupted by filter 15 for color balance adjustment.

Accordingly, in the present embodiment, when light output is reduced from level A to level A′, light leakage when black information is displayed is also reduced in the same proportion from level C to level C′. The contrast ratio is therefore CR′=A′/C′=CR and is maintained despite adjustment of peak level light output and reduction to level A′ for adjustment of color balance.

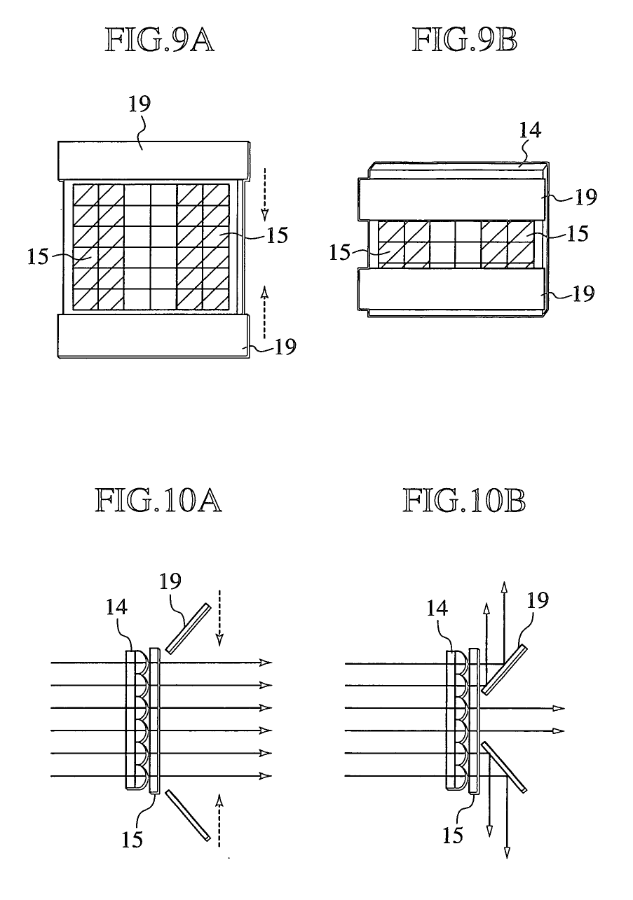

FIG. 9A, FIG. 9B, FIG. 10A and FIG. 10B are front and side views illustrating a state in which the filter 15 and barrier member 19 are provided after the lens array 14.

In FIG. 9A, FIG. 9B, FIG. 10A and FIG. 10B, the filter 15 is positioned in a direction perpendicular to the optical axis of the lens array 14 and in either side separated from the optical axis (the vertical direction in the drawing) while the barrier members 19 are arrayed in another direction perpendicular to the optical axis of the lens array 14 and the direction in which the filter 15 is arranged, horizontally and either side (in the top part and bottom part in the drawing). In FIG. 9A and FIG. 10A, the barrier members 19 are withdrawn from the path of the light emitted from the lens array 14 and color temperature is set by the filter 15, however the light is not interrupted by the barrier members 19 such that intensity of the illumination is high (bright).

In FIG. 9B and FIG. 10B, the barrier members 19 are inserted into the path of the light emitted from the lens array 14, color temperature is set by the filter 15 and the light is interrupted by the barrier members 19 and the intensity of the illumination is low (dark).

In the embodiment illustrated in FIG. 9A and FIG. 9B, the barrier members 19 are comprised of a barrier plate positioned at an angle to the optical path. In this case, when the barrier members 19 are comprised of a mirror reflecting light beams of all wavelength regions, the interrupted light beam is not returned towards the light source and it is possible to prevent an increase in the temperature of the light source and light source parts.

Moreover, it is preferable that filter 15 and a barrier member 19 are provided such that light is reduced and interrupted in increments corresponding to each segment of the lens array 14 to avoid irregular coloring in the projected image. Further, the filter 15 and barrier member 19 are not restricted to being positioned after the secondary lens array 14 as illustrated in FIG. 6A and FIG. 6B, but may be positioned between the primary and secondary lens arrays 13 and 14.

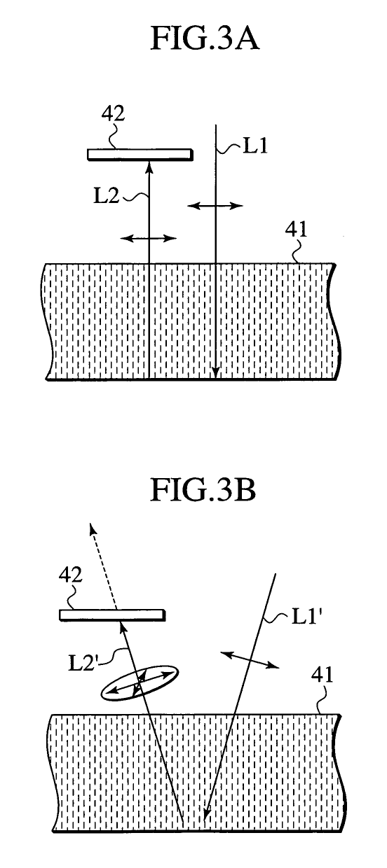

As described above, in these embodiments the actual diameter of a light beam is reduced and the F-number increased by filter 15, or by the filter 15 and barrier member 19. The image display apparatuses of these embodiments are therefore appropriate for a vertical or small angle of incidence for illuminating light directed to the liquid crystal panel as illustrated in FIG. 3A. That is to say, in these embodiments the configuration is such that light leakage and light output when black information is displayed, are small.

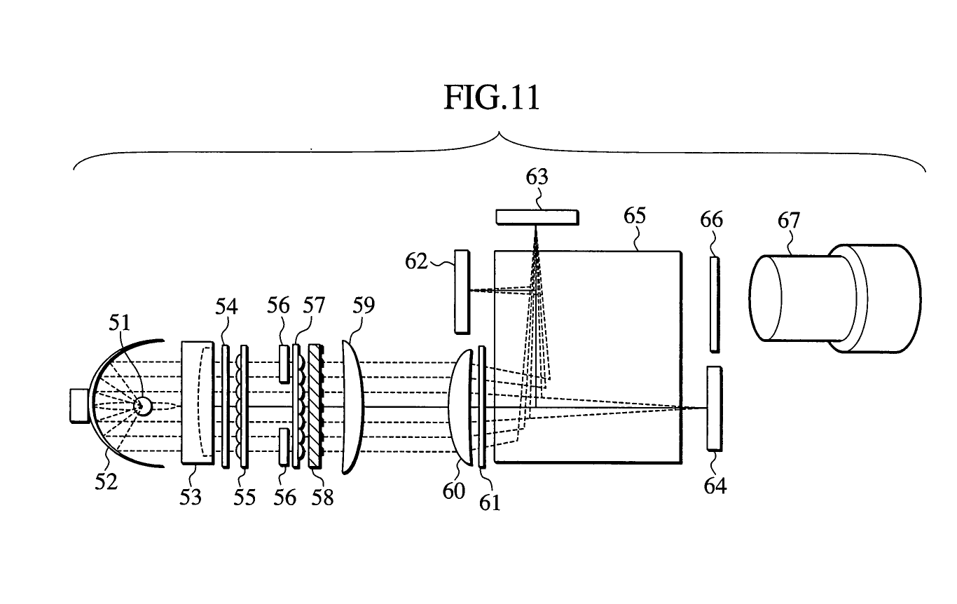

FIG. 11 is a side view illustrating in greater practical detail a configuration of an image display apparatus of this embodiment.

This image display apparatus illustrates in greater detail, including the color separation and synthesis optics system, the image display apparatus having the lens array system illustrated in FIG. 4A.

This image display apparatus comprises a light source 51, a reflector 52 reflecting the light from the light source 51 in a single direction, a collimator lens 53, a cut-off filter 54 interrupting red and ultraviolet light, a primary lens array 55, a filter 56, a secondary lens array 57, a combiner 58, a superimposing lens 59, a condenser lens 60 and a polarizer (polarizing panel) 61.

The collimator lens 53 receives light from the reflector 52 and forms an almost parallel beam of light to improve the efficiency with which light is used.

The cut-off filter 54 interrupts red and ultraviolet light not required for display of the image, thus preventing heating of the optics system in subsequent stages.

The primary and secondary lens arrays 54 and 57 and the superimposing lens 59, comprise a means for convoluted illumination for convoluted illumination of the liquid crystal light valve with a plurality of tertiary images of the light source formed on the superimposing lens 59.

The filter 56 is positioned between the primary and secondary lens arrays 54 and 47 and provides control to interrupt light beams far from the optical axis in wavelength regions for which the level is reduced and pass light beams close to the optical axis unrestricted. Color balance (light balance) for this image display apparatus is adjusted by restricting the intensity of light beams restricted to those wavelength regions.

The combiner 58 converts incident light to S-polarized light to raise the efficiency of use of the light in the polarizing system in subsequent stages.

The condenser lens 60 operates such that the light illuminating the liquid crystal light valve is directed in the direction of the incident iris of the projection lens.

The polarizer 61 operates such that only S-polarized light passes.

Further, this image display apparatus comprises a color separation and synthesis optics system 65, a B liquid crystal light valve 62, an R liquid crystal light valve 63, a G liquid crystal light valve 64, an analyzer 66 and a projection lens 67.

The color separation and synthesis optics system 65 separates the incident light into RGB light (the three primary colors), directs each to the respective liquid crystal light valves 62, 63 and 64 and synthesizes the separated RGB light modulated and reflected by the liquid crystal light valves 62, 63 and 64.

As a variety of configurations are possible for the color separation and synthesis optics system 65 employing prisms and dichroic mirrors, drawings illustrating configurations in practical detail are omitted. Only the optical path up to the liquid crystal light valves 62, 63 and 64 is shown in the color separation and synthesis optics system 65 block in the drawing.

The analyzer 66 (polarizing panel) passes only P-polarized light. Light not modulated by the liquid crystal light valves 62, 63 and 64 is therefore interrupted by this analyzer 66.

The projection lens 67 projects the light passing through the analyzer 66 onto a screen.

In this embodiment, the optics system may be configured with an F-number of, for example, 2.4. In this case the maximum incident angle of the light directed to the spatial light modulating elements (liquid crystal light valves 62, 63 and 64) is 11.8 degree. Here, if for example, the B light emitted from the image display apparatus is to be reduced by 50%, the F-number is changed from 2.4 to 3.4. The maximum incident angle of the light directed to the spatial light modulating elements is then 8.4 degree.

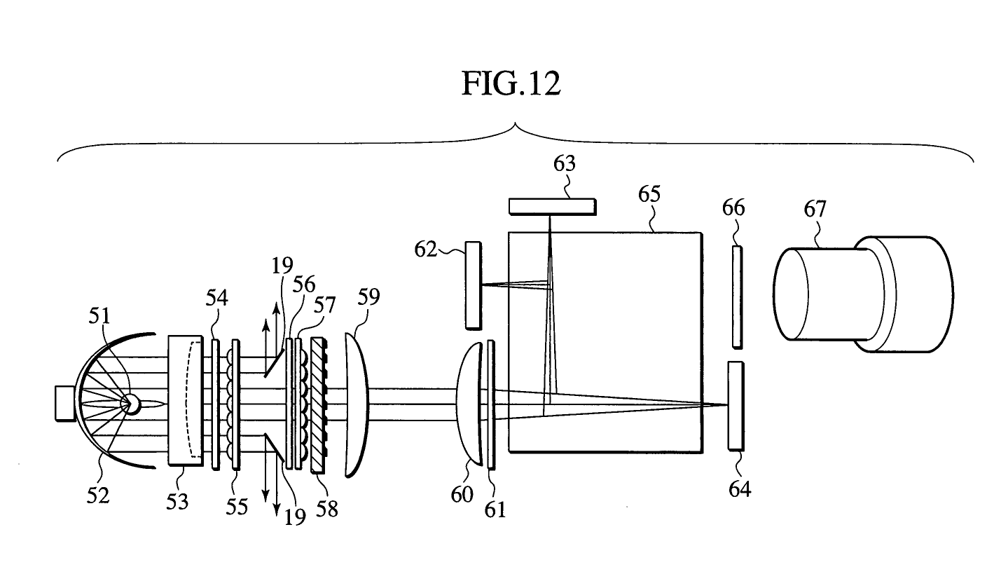

FIG. 12 is a side view of the image display apparatus illustrated in FIG. 11 in which a barrier member is provided.

In this embodiment, a barrier member 19 is provided between the primary lens array 55 and the filter 56 in the image display apparatus illustrated in FIG. 11. As illustrated in FIG. 9A and FIG. 9B, this barrier member 19 is a barrier plate positioned at an angle to the optical path and comprises a mirror reflecting all wavelength regions in the light beam. The light beam interrupted by this barrier member 19 is therefore not returned to the light source and the temperature of the light source and light source parts does not increase.

In this embodiment, the actual diameter of the light beam is reduced and the F-number increased by the filter 15 and barrier member 19 and the angle of incidence of light illuminating the liquid crystal light valves is either vertical or a small angle. Accordingly, in this embodiment, light leakage and light output when black information is displayed are small.

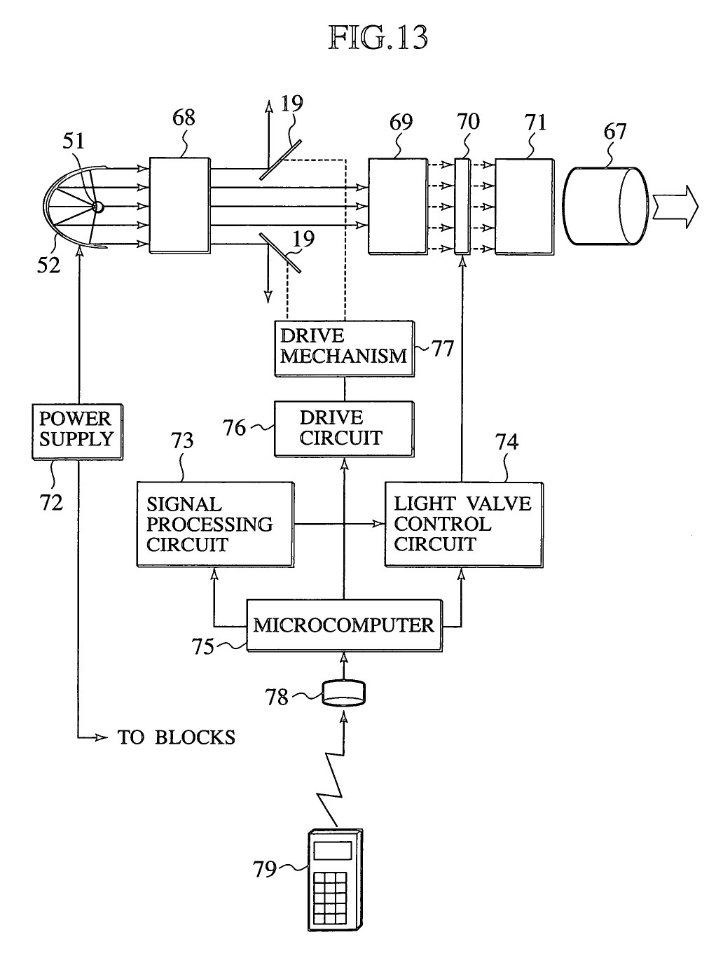

FIG. 13 is a side view illustrating a configuration of a mechanism for movement of the barrier member 19 in the image display apparatus in this embodiment.

This image display apparatus comprises a light source 51, a reflector 52 reflecting the light from the light source 51 in a single direction and an illumination optics system 68 for a means for convoluted illumination. As with the embodiment described previously, this illumination optics system 68 comprises a collimator lens, a cut-off filter interrupting red and ultraviolet light, primary and secondary lens arrays, a filter for color balance (white balance) adjustment, a combiner, a superimposing lens, a condenser lens and a polarizer (polarizing panel).

Part of the light emitted from this illumination optics system 68 is interrupted by the barrier member 19 and directed to the color separation system 69. As illustrated in FIG. 10A and FIG. 10B, the barrier member 19 is a barrier plate positioned at an angle to the optical path and comprises a mirror reflecting light beams of all wavelength regions. The light beam interrupted by this barrier member is therefore not returned towards the light source and the temperature of the light source and light source parts does not increase.

The illuminating light separated into RGB light (the three primary colors) in the color separation optics system is directed to the spatial light modulating elements 70 comprised of a B liquid crystal light valve, an R liquid crystal light valve and a G crystal light valve, passes through the spatial light modulating elements 70 and is directed to the color synthesis optics system 71.

As a variety of configurations are possible for the color separation optics system 69 and the color synthesis optics system 71 employing prisms and dichroic mirrors, drawings illustrating configurations in practical detail are omitted.

The RGB light (the three primary colors) synthesized in the color synthesis system 71 is directed to the projection lens 67 from which it is projected onto the screen (not shown in drawing).

A drive mechanism 77 to move the barrier member 19 in a direction perpendicular to the optical axis of the illuminating light is provided in this image display apparatus. This drive mechanism 77 is driven and controlled by a microcomputer 75 via a drive circuit 76.

Moreover, this microcomputer 75 controls a signal processing circuit 73 and a light valve drive circuit 74. This signal processing circuit 73 controls the spatial light modulating elements 70 via the light valve control circuit 74 based on an image signal supplied from an external source.

A photodetector 78 is connected to the microcomputer 75 to receive remote control signals from a remote controller 79.

The various blocks and the light source 51 are supplied with power from and operate with, a power supply 72.

In this embodiment of the image display apparatus the remote controller 79 may be used, via the photodetector 78, microcomputer 75 and drive circuit 76, to move the barrier member 19 in a direction perpendicular to the optical axis of the illuminating light. In this image display apparatus, the actual diameter of the light beam emitted from the illumination optics system 68 may be variably adjusted by movement of the barrier member 19, the F-number is variable and the incident angle of the illuminating light directed to the liquid crystal light valves may be adjusted. This adjustment reduces light leakage in the liquid crystal light valves and reduces light output when black information is displayed.

The above-described embodiment of the present invention is presented by way of example only, and is illustrative rather than restrictive. It is apparent to those skilled in the art that changes and modifications are to be understood as included within the scope of the present invention as defined by the appended claims unless they depart therefrom.

What is claimed is:

1. An image display apparatus comprising:
a white light source for emitting white light in the form of a light beam of a prescribed cross-sectional area;
three spatial light modulating elements for modulating three primary colors, respectively;
a focusing lens for focusing the light beam emitted from the white light source;
a primary means of adjustment for adjusting the color balance of the white light entering or leaving the focusing lens;
means of separating and synthesizing for separating the three primary colors of light for which color balance has been adjusted with the primary means of adjustment, for directing light of the three primary colors to the three spatial light modulating elements and for synthesizing light of the three primary colors modulated with the three spatial light modulating elements; and
means of projection for projecting light synthesized with the means of separating and synthesizing.

2. The image display apparatus of claim 2, further comprising:
a barrier member for blocking all wavelength regions of the white light in at least part of a light beam entering or leaving the focusing lens; and
a secondary means of adjustment for adjusting the intensity of the white light in a light beam in which all wavelength regions are interrupted by the barrier member.

3. The image display apparatus of claims 1, wherein a lens array, a glass rod, or an internally reflecting columnar mirror is provided between the white light source and the focusing lens.

4. The image display apparatus of claims 2, wherein a lens array, a glass rod, or an internally reflecting columnar mirror is provided between the white light source and the focusing lens.
